(19) United States
(12) Patent Application Publication
(10) Pub. No.: US 2004/0014496 A1
(43) Pub. Date: Jan. 22, 2004

(54) Dual slot card receiving apparatus for mobile communication device

(76) Inventors: Liang-Xin Chen, Shanghai (CN); Shin-Ying Lin, Shanghai (CN)

Correspondence Address: BIRCH STEWART KOLASCH & BIRCH, PO BOX 747, FALLS CHURCH, VA, 22040-0747, US

(21) Appl. No.: 10/198,111

(22) Filed: Jul. 19, 2002

(51) Int. Cl. H04M 1/00

(52) U.S. Cl. 455/558; 455/575.1; 455/90.3

(57) ABSTRACT

A dual slot card receiving apparatus for a mobile communication device includes a circuit board, a first connector, a second connector, and an arranging card device. The first connector is provided on the circuit board and electrically connected with the circuit board. The second connector is coupled with the circuit board and corresponds to the first connector, thereby forming a space between the second connector and the circuit board. The card arranging device is put into the space and has a concave portion in either side to received a first card and a second card. The first card is coupled to the circuit board through the first connector, and the second card is coupled to the circuit board through the second connector.

### FIELD OF THE INVENTION

The present invention relates to a card receiving apparatus, and more particularly relates to a dual slot card receiving apparatus for a mobile phone which can receive two subscriber identity module cards (SIM card) or other kinds of IC card simultaneously.

### DESCRIPTION OF THE RELATED ART

As network communication rapidly improves and the fabrication cost is reduced, the mobile phone has become one of the most popular communication appliances.

The user can receive or send communication anywhere by the mobile phone. However, the is user unable to use the mobile phone when the mobile communication service of the SIM card is not available because mobile communication service providers generally provide local service only. Nevertheless the user is able to use the mobile phone if his or her mobile communication service provider provides an international roaming service. The charge of the international roaming service is expensive because of the international roaming cost includes communication cost and registering cost. Therefore the user may have different SIM cards to use in different locations.

The user may also switch between SIM cards depending on which offers lower charges for the mobile communication service.

However, the size of the SIM card is small, so receiving and replacing the card is not easy. In addition, SIM cards are easily damaged if handled and exposed circuitry due to their delicate construction.

### SUMMARY OF THE INVENTION

Accordingly, the object of the present invention is to provide a dual slot card receiving apparatus for a mobile communication device, so that the user can use different cards of different mobile communication services, thereby reducing the time spent switching the SIM cards. The mobile communication service offered by the providers of the different SIM card can be selected automatically or by the user.

The present invention provides a dual slot card receiving apparatus for a mobile communication device comprising a circuit board, a first connector, a second connector, and a card arranging device. The first connector is provided on the circuit board and electrically connected with the circuit board. The second connector is coupled to the circuit board and corresponds to the first connector thereby forming a space between the second connector and the circuit board. The card arranging device has slots in either side to receive a first card and a second card. The first card is connected with the circuit board through the first connector and the second card is connected with the circuit board through the second connector.

### BRIEF DESCRIPTION OF THE DRAWINGS

The present invention will become more fully understood from the detailed description given herein and the accompanying drawings, given by way of illustration only and thus not intended to be limited of the present invention.

FIG. 1a depicts the first connector of the present invention;

FIG. 1b depicts a front view of the second connector of the present invention;

FIG. 1c depicts a back view of the second connector of the present invention;

FIG. 2a depicts the first connector and the second connector coupled to the circuit board of the present invention;

FIG. 2b depicts the dual slot card receiving apparatus is put into the device which shown in FIG. 1a of the present invention;

FIG. 3a depicts the card receiving arranging apparatus received into the first and second connector to form the dual slot card receiving apparatus of the present invention;

FIGS. 3b to 3c depicts the SIM card of the present invention;

FIG. 3d depicts the SIM card received into the card arranging device of the present invention; and

FIG. 4 depicts the dual slot card receiving apparatus of the present invention used in a mobile phone.

### DETAILED DESCRIPTION OF THE PREFERRED EMBODIMENTS

### Embodiment

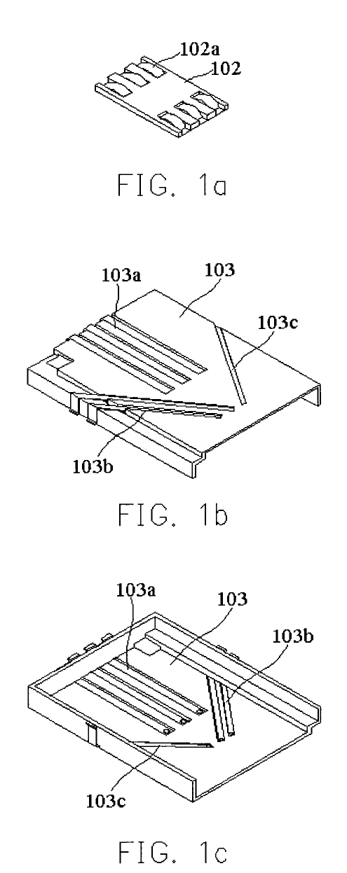

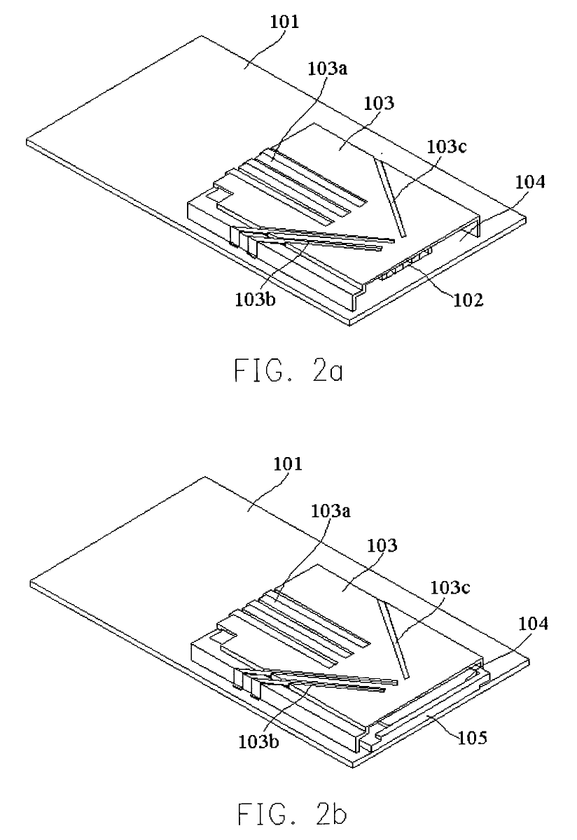

A detailed description of the dual slot card receiving apparatus for a mobile communication device of the present invention is given hereafter with reference to FIGS. 1a to 1c and 2a to 2b.

A first connector of the present invention is shown in FIG. 1a, and the front view and the back view of a second connector of the present invention is shown in FIGS. 1b and 1c.

The first connector and second connector are coupled to a circuit board as shown in FIG. 2a. FIG. 2b shows an card arranging device received into a device which shown in FIG. 2a.

A SIM card 107 conducted to the circuit board 101 through a connective pad 102a which on the first connector 102. The first connector 102 electrically connected to the circuit board 101 and installed thereon. The connective pad 102a can be an electrode.

A SIM card 106 is electrically connected to the circuit board 101 through a connective pad 103a the second connector 103. Electric connecting component 103b and 103c are on the second connector 103 with the connective pad 103a. The second connector 103 is electrically connects with the circuit board 101 through the electric connecting component 103b to 103c. A space 104 is formed between the second connector 103 and the circuit board 101, and an card arranging device 105 of the present invention is put into the space 104 as FIG. 2b shown.

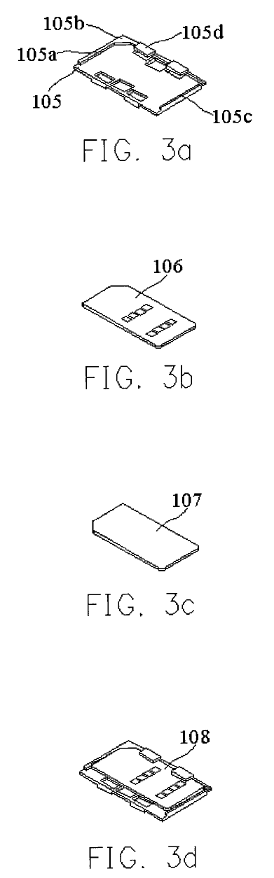

Next, the card arranging device 105 of the present invention is shown as FIG. 3a, and the SIM card 106 and 107 are shown as FIGS. 3b to 3c.

The card arranging device 105 has a concave portion 105a on either side. The SIM cards 106 and 107 are put into the concave portions 105a respectively. Each concave portion 105a is provided with an inclined portion 105b, a flange 105c, and a hook 105d.

The inclined portion 105b allows the conductive interface (not shown) of the SIM card 106 and 107 to face outward when the SIM card 106 or 107 is put into a concave portion 105a. The flange 105c keeps the SIM card 106 or 107 in the concave portion 105a. The hook 105d locks the SIM card 106 or 107 of the concave portion 105.

The card arranging device 105 received into a space between the first and second connector on the dual slot card receiving apparatus 108 of the present invention is shown as FIG. 3d, and the SIM card 106 or 107 is put into the card arranging device 105.

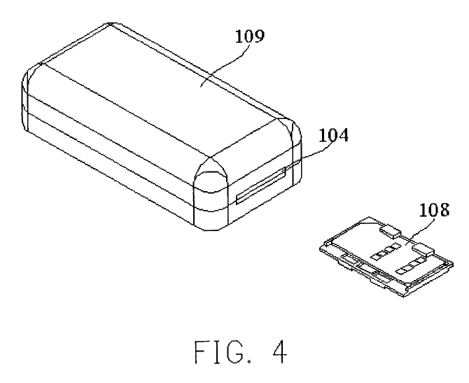

The dual slot card receiving apparatus of the present invention used in a mobile phone is shown in FIG. 4. The circuit board 101, which has the first connector 102 and the second connector 103, is installed in the mobile phone 109, and the first connector 102 and second connector 103 are electrically connected to the circuit board 101. The opening 104 which forming between the second connector 103 and the circuit board 101 is exposed, and the user may put the card arranging device 105 into the mobile phone 109 via the opening 104 easily.

According to the dual slot card receiving apparatus of the present invention, the user could use two SIM cards of different mobile communication service at the same time. The mobile communication service of the SIM card of the mobile phone can be selected automatically or by the user. The user can choose the preferable mobile communication service of the providers thereby spending less in mobile communication.

Conventionally, the mobile communication service is changed by changing the SIM card in the mobile phone. The SIM cards are damaged if the SIM card in the mobile phone repeatedly exchanged, thereby reducing their lift time. It is unnecessary remove or replace the SIM cards in the phone when the mobile communication services are alternated.

While the present invention is described by preferred embodiments, it should be understood that the invention is not limited to these embodiments in anyway. On the contrary, it is intended to cover all the modifications and arrangements as they would be apparent to those skilled in the art. Therefore, the scope of the appended claims should be interpreted in the broadest sense so as to encompass all the modifications and arrangements.

What is claim is:

1. A dual slot card receiving apparatus for a mobile communication device, comprising:
a circuit board;
a first connector, provided on the circuit board and electrically connected with the circuit board;
a second connector, coupled to the circuit board and corresponding to the first connector, a space being formed between the second connector and the circuit board; and
a card arranging device, which has concave portions on either side to receive a first card and a second card, and the card arranging device being received in the space, the first card coupled with the circuit board through the first connector and the second card coupled with the circuit board through the second connector.

2. The dual slot card device according to claim 1, wherein the first connector has an electrode.

3. The dual slot card device according to claim 1, wherein the second connector has an electrode.

4. The dual slot card device according to claim 1, wherein the card arranging device is made of nonconductor material.

5. The dual slot card device according to claim 1, wherein an inclined portion is in each concave portion.

6. The dual slot card device according to claim 1, wherein the card is a SIM card.

7. The dual slot card device according to claim 1, wherein the card is a smart card.
